(19) United States
(12) Patent Application Publication
(10) Pub. No.: US 2012/0094514 A1
(43) Pub. Date: Apr. 19, 2012

(54) CARD CONNECTOR WITH SWITCH UNIT

(75) Inventors: Liang SUN, Shenzhen (CN); Nan HU, Shenzhen (CN)

(73) Assignee: HON HAI PRECISION INDUSTRY CO., LTD., New Taipei (TW)

(21) Appl. No.: 13/236,064

(22) Filed: Sep. 19, 2011

(30) Foreign Application Priority Data
Oct. 14, 2010 (CN) 201020561375.2

(51) Int. Cl. H01R 13/703; H01R 13/62

(52) U.S. Cl. 439/159; 439/620.21

(57) ABSTRACT

A card connector (100) includes an insulative housing (2), a number of terminals (3) retained in the insulative housing, a metal shell (1) covering the insulative housing for defining a card receiving space, a switch unit comprising a moveable contact (4) retained in the insulative housing and an immoveable contact (14) integrally extending from the metal shell, and a support plate (233) pivotally assembled on the insulative housing. The immoveable contact includes a contacting portion (142). The moveable contact is cantilevered above the contacting portion of the immoveable contact for detecting an electrical card. The support plate is rotatable to be located beneath the contacting portion of the immoveable contact.

### BACKGROUND OF THE INVENTION

1. Field of the Invention

The present invention relates generally to a card connector, and more particularly to a card connector which has a moveable contact cooperating with the metal shell as an immoveable contact to form a switch unit.

2. Description of Related Arts

A conventional card connector 100′ as shown in FIG. 5 usually has an insulative housing 2′, a plurality of terminals 3′ retained in the insulative housing 2′, a metal shell 1′ covering the insulative housing 2′, and a switch unit detecting insertion of a card. The switch element comprises a moveable contact 4′ retaining in the insulative housing 2′ and an immoveable contact 142′ extending downward from a front end of the metal shell 1′ which is distant from a card insertion opening. The moveable contact 4′ is located above the immoveable contact 142′ of the metal shell 1′ and is therefore separated from the immoveable contact 142′ a certain distance therebetween when the card is not inserted, at which the switch unit is in an “OFF” status. The moveable contact 4′ is pressed down to contact with the immoveable contact 142′ by the inserted card, at which the switch unit is in an “ON” status. Therefore, whether the card is inserted or not is detected by the switch unit. The metal shell 1′ further comprises a plurality of soldering pads 122′ formed at a rear end thereof which is adjacent to the card insertion opening. The soldering pads 122′ are surface mounted on a printed circuit board (not shown) through which a high temperature is needed. The rear end of the insulative housing 2 is prone to be warped and, therefore, the rear end of the metal shell 1′ is raised up, resulting in that the immoveable contact 142′ at the front end of the metal shell 1′ moves down and the distance between the moveable contact 4′ and the immoveable contact 142′ is enlarged such that detection for the card is adversely affected.

Hence, a card connector having an improved switch unit for effectively detecting the card is desired to overcome the aforementioned disadvantage of the prior art.

### SUMMARY OF THE INVENTION

Accordingly, an object of the present invention is to provide a card connector having an improved switch unit for effectively detecting the card.

To achieve the above object, a card connector includes an insulative housing, a number of terminals retained in the insulative housing, a metal shell covering the insulative housing for defining a card receiving space, a switch unit comprising a moveable contact retained in the insulative housing and an immoveable contact integrally extending from the metal shell, and a support plate pivotally assembled on the insulative housing. The immoveable contact includes a contacting portion. The moveable contact is cantilevered above the contacting portion of the immoveable contact for detecting an electrical card. The support plate is rotatable to be located beneath the contacting portion of the immoveable contact.

Other objects, advantages and novel features of the invention will become more apparent from the following detailed description when taken in conjunction with the accompanying drawings.

### BRIEF DESCRIPTION OF THE DRAWINGS

FIG. 1 is a perspective, assembled view of a card connector constructed in accordance with the present invention;

FIG. 2 is a perspective, partly exploded view of the card connector when the metal shell is separated therefrom;

FIG. 3 is a perspective, fully exploded view of the card connector;

FIG. 4 is another view of FIG. 3; and

FIG. 5 is a perspective, assembled view of a conventional card connector.

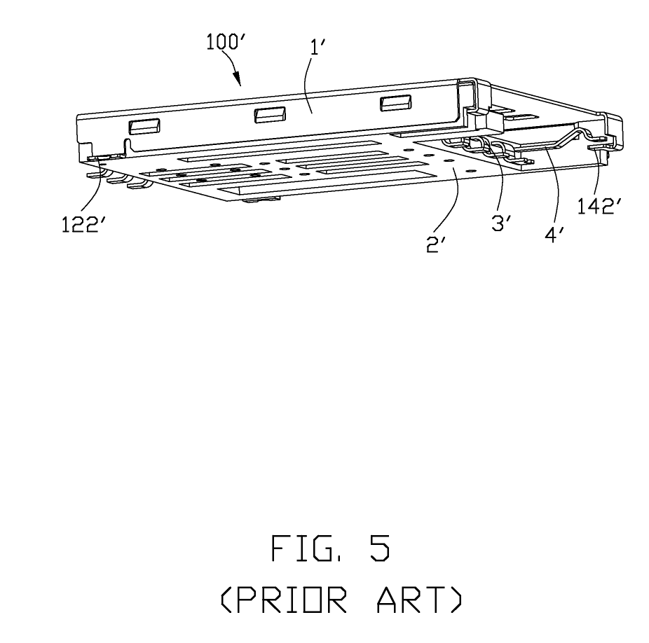

### DETAILED DESCRIPTION OF THE PREFERRED EMBODIMENT

Reference will now be made in detail to the preferred embodiment of the present invention.

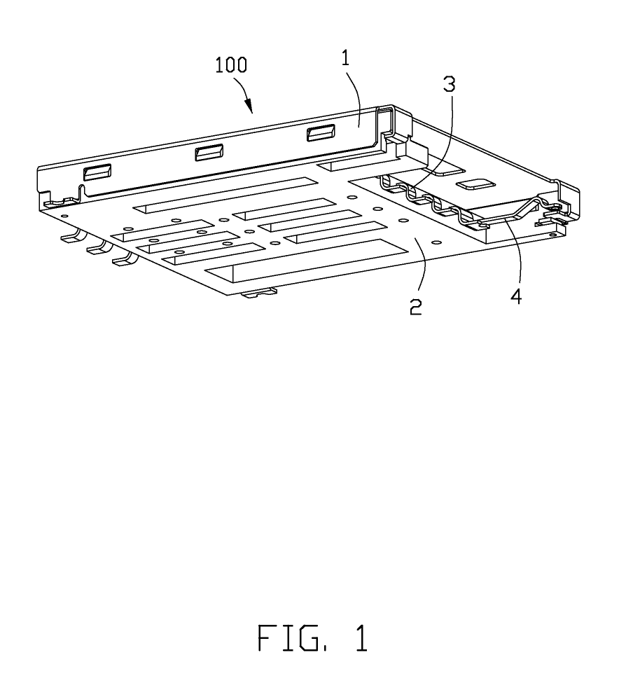

Referring to FIGS. 1-4, a card connector 100 in accordance with the present invention, used for receiving an electrical card (not shown), comprises an insulative housing 2, a plurality of terminals 3 retained in the insulative housing 2, a metal shell 1 covering the insulative housing 2 for shielding, a moveable contact 4 retained in the insulative housing 2, and an ejector 5 assembled at the opposite side of insulative housing 2 relative to the moveable contact 4. The card connector 100 defines a card receiving space (not labeled) between the metal shell 1 and the insulative housing 2 for receiving the electrical card.

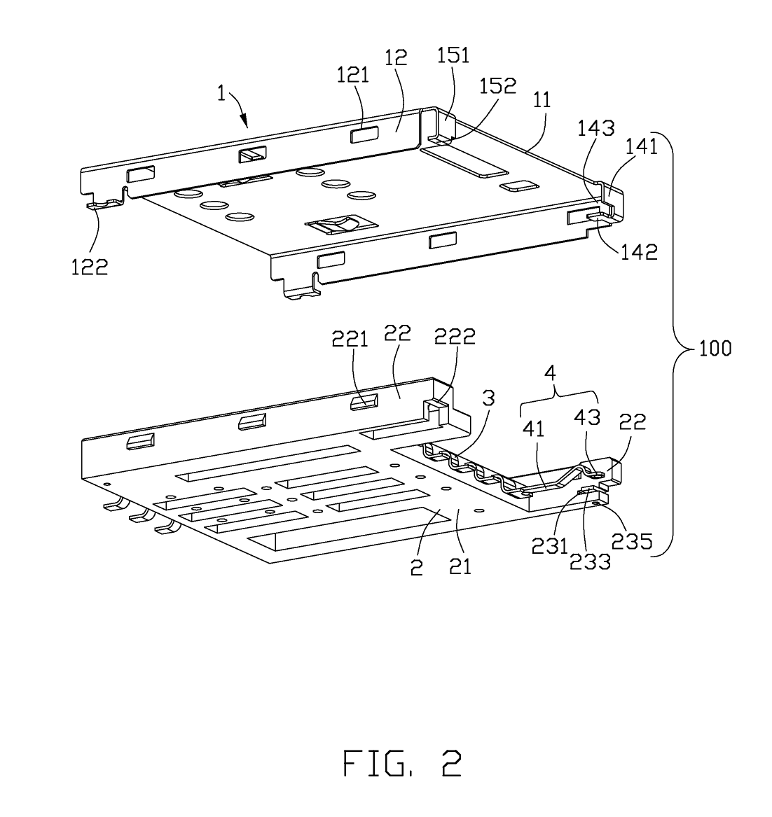

Referring to FIGS. 2-4, the metal shell 1 comprises a main portion 11 and a pair of sidewalls 12 extending vertically from two opposite edges of the main portion 11. Each sidewall 12 defines a plurality of cutouts 121 and forms a soldering pad 122 at a rear end thereof The metal shell 1 forms an immoveable contact 14 at a left, front edge of the main portion 11. The immoveable contact 14 comprises a connecting portion 141 connecting to the main portion 11 and a contacting portion 142 bending vertically from the connecting portion 141 towards card receiving space. The contacting portion 142 extends parallel to the main portion 11 and therefore, an interspace 143 is defined between the main portion 11 and the contacting portion 142. The metal shell 1 forms a securing portion 15 comprising a vertical portion 151 connecting to the right, front edge of the main portion 11 and a horizontal portion 152 bending vertically from the vertical portion 151 towards the card receiving space.

Referring to FIGS. 1-4, the terminals 3 are positioned in two rows along a card insertion/ejection direction. The terminals 3 comprise a plurality connection portions (not labeled) extending above an upper surface of the insulative housing 2 into the card receiving space for connecting with the electrical card and a plurality of soldering portions (not labeled) exposed out of the insulative housing 2 from two opposite ends of the insulative housing 2 for being soldered on a printed circuit board (not shown). Therefore, signals are transmitted between the electrical card and the printed circuit board via the terminals 3.

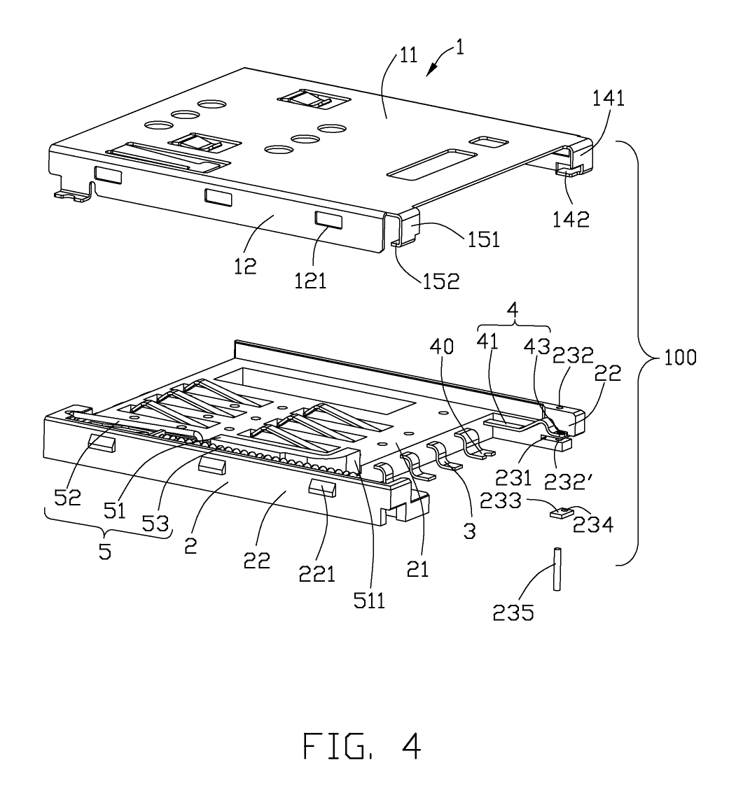

Referring to FIG. 4, the ejector 5 is assembled at the right side of the terminals 3. The ejector 5 comprises a slider 51 with a pushing bar 511 bending vertically towards the card receiving space and moveable along the card insertion/ejection direction with the electrical card, a pin member 52 with one end secured on the insulative housing 2 and the other end moveably guided by the slider 51, and a spring 53 compressed between the insulative housing 2 and the slider 51 for urging the slider 51 along the card ejection direction. The principle of the ejector 5 is well known to persons skilled in the art, and it will be not described in detail herein. The moveable contact 4 is assembled at the front, left side of the terminals 3, which is opposite to the ejector 5. Because the moveable contact 4 and the ejector 5 are assembled at opposite sides of the terminals 3, the pushing bar 511 of the slider 51 will be never interference with the moveable contact 4 during insertion of the electrical card into the card receiving space.

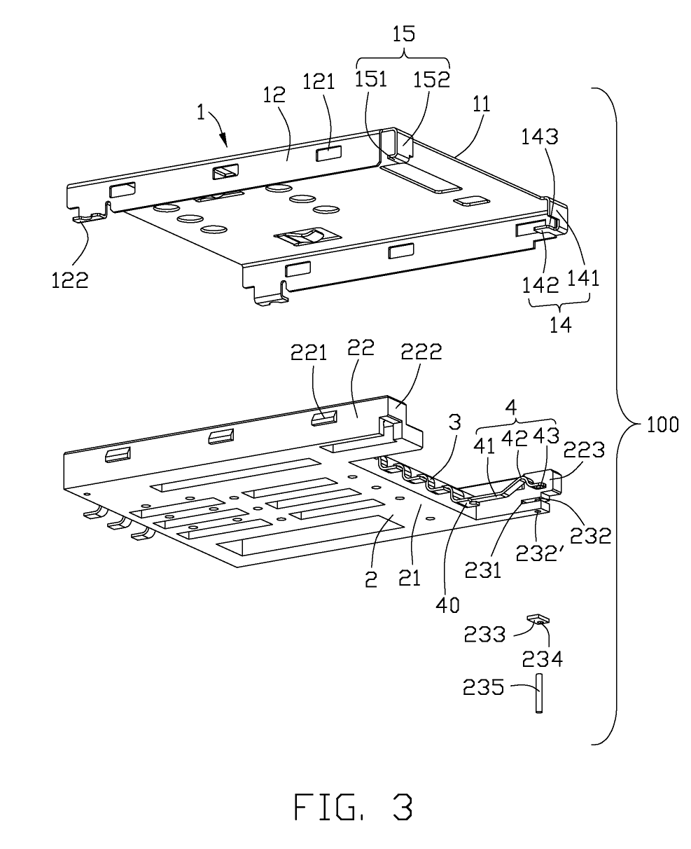

Referring to FIGS. 3 and 4, the moveable contact 4 comprises a soldered pad 40 arranged at the front end of the insulative housing 2, a linking portion 41 curvedly extending from the soldered pad 40, an arch portion 42 extending upwardly and forwardly from the linking portion 41 toward the card receiving space, and a tail portion 43 connecting to the arch portion 42. The tail portion 43 is received in the interspace 143. The tail portion 43 is cantilevered above the contacting portion 142 of the immovable contact 14 before the electrical card is inserted into the card connector 100 and then is pressed down by the electrical card to connect with the contacting portion 142 of the immovable contact 14 after the electrical card is inserted into the card connector 100. Therefore, detection for the electrical card is achieved.

Referring to FIGS. 1-4, the insulative housing 2 comprises a base portion 21 and a pair of lateral walls 22 extending upwardly from two opposite edges of the base portion 21. Each lateral wall 22 forms a plurality of protrusions 221 securely received in the cutouts 121 of the metal shell 1 such that the metal shell 1 is securely assembled on the insulative housing 2. Both lateral walls 22 extend beyond the base portion 21 along the card insertion direction and form a left securing bar 223 and a right securing bar 222 at free ends thereof The right securing bar 222 defines a notch 222 from a lower surface thereof and the horizontal portion 152 is retained in the notch 222 for strengthening orientation between the metal shell 1 and the insulative housing 2. The left securing bar 223 defines a gap 231. The left securing bar 223 is divided into upper and lower parts (not labeled) by the gap 231. The upper part of the left securing bar 223 defines a first aperture 232 and the lower part of left securing bar 223 defines a second aperture 232′ corresponding to the first aperture 232 along a vertical direction which is perpendicular to the card insertion/ejection direction. Both the first aperture 232 and the second aperture 232′ are communicated with the gap 231. A support plate 233 defines a third aperture 234 and therefore, a shaft 235 is retained in the first, second, and third apertures 232, 234, 232′. Accordingly, the support plate 232 is rotatable around the shaft 235 and the support plate 233 is pivotally received in the gap 231. Namely, the support plate 232 can be exposed out of the gap 231 and be located beneath the contacting portion 142 of the immoveable contact 14 for supporting the immoveable contact 14 when the soldering pads 122 of the metal shell 1 are soldering on the printed circuit board and is rotatable to be hidden in the gap 231 for better detection between the moveable contact 4 and the immoveable contact 14 after the soldering pads 122 of the metal shell 1 are soldered on the printed circuit board. The main portion 11 of the metal shell 1, the tail portion 43 of the moveable contact 4, the contacting portion 142 of the immoveable contact 14, and the support plate 233 are positioned along the vertical direction.

Because the support plate 232 is exposed out of the gap 231 and is located beneath the contacting portion 142 of the immoveable contact 14 for supporting the immoveable contact 14 when the soldering pads 122 of the metal shell 1 are soldering on the printed circuit board, the contacting portion 142 of the immoveable contact 14 is prevented from moving down. Therefore, an interspace between the movable contact 4 and the immoveable contact 14 is prevented from being enlarged and better detection of the switch unit for the electrical card is guaranteed.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A card connector comprising:
an insulative housing;
a plurality of terminals retained in the insulative housing;
a metal shell covering the insulative housing for defining a card receiving space;
a switch unit comprising a moveable contact retained in the insulative housing and an immoveable contact integrally extending from the metal shell, the immoveable contact comprising a contacting portion, the moveable contact being cantilevered above the contacting portion of the immoveable contact for detecting an electrical card; and
a support plate pivotally assembled on the insulative housing, the support plate being rotatable to be located beneath the contacting portion of the immoveable contact.

2. The card connector as claimed in claim 1, wherein the insulative housing defines a gap receiving the support plate.

3. The card connector as claimed in claim 2, wherein the insulative housing defines a first aperture and a second aperture both communicating with the gap and a shaft is retained in the first and second apertures.

4. The card connector as claimed in claim 3, wherein the support plate defines a third aperture through which the shaft extends and the support plate is pivotal around the shaft.

5. The card connector as claimed in claim 2, wherein the insulative housing comprises a base portion and a pair of lateral walls extending beyond the base portion, and the gap is defined on one of the lateral walls.

6. The card connector as claimed in claim 5, wherein the metal shell comprises a securing portion and the other one of the lateral wall defines a notch secured with the securing portion.

7. The card connector as claimed in claim 1, wherein the metal shell comprises a main portion and a soldering pad extending from the main portion, the moveable contact comprises a soldered pad, and wherein the soldering pad and the soldered pad are positioned at opposite ends of the insulative housing.

8. The card connector as claimed in claim 7, wherein the immoveable contact comprises a connecting portion connecting between the main portion and the contacting portion, and wherein the immoveable contact is surface mounted via the soldering pad.

9. The card connector as claimed in claim 8, wherein an interspace is defined between the main portion and the contacting portion and the movable contact comprises a tail portion extending into the interspace.

10. The card connector as claimed in claim 1, further comprising an ejector, and wherein the ejector comprises a slider having a pushing bar bent vertically into the card receiving space.

11. The card connector as claimed in claim 10, wherein the moveable contact and the ejector are assembled at opposite sides of the terminals.

12. An electrical card connector for use with an electronic card, comprising:
an insulative housing defining a receiving cavity for allowing the electronic card to be inserted thereinto in a front-to-back direction;
a plurality of contacts disposed in the housing with contacting sections extending into the receiving cavity;
a metallic shell assembled to the housing in a vertical direction perpendicular to said front-to-back direction, said shell including a solder pad for mounting to a printed circuit board only around a front region;
a switch including a movable contact disposed in the housing around a rear region of the shell and moveable up and down in the vertical direction, and an immoveable contact unitarily formed on the rear region of the shell and adapted to be engaged with moveable contact in the vertical direction; and
a supporting plate associated with the housing around the rear region of the shell; wherein
said support plate is moveable between a first position where the rear region of the shell is upwardly supported by the support plate for correctly soldering the shell to the printed circuit board so as to assure the immoveable contact is located at a correct level, and a second position where the support plate no longer supports the rear region of the shell for facilitates operation of the switch.

13. The electrical card connector as claimed in claim 12, wherein the support plate is moveable horizontally perpendicular to the vertical direction.

14. The electrical card connector as claimed in claim 13, wherein said support plate is moveable in a rotation manner about a vertical pin.

15. The electrical card connector as claimed in claim 12, wherein the support plate directly supports the immoveable contact at the first position.

16. The electrical card connector as claimed in claim 12, wherein the support plate is exposed to an exterior at the first position while is essentially hidden from the exterior at the second position.

17. The electrical card connector as claimed in claim 12, wherein the shell defines a main plate covering the receiving cavity in the vertical direction, and the immovable contact downwardly extend unitarily from a rear edge of the main plate.
